(19) United States
(12) Patent Application Publication
(10) Pub. No.: US 2014/0378353 A1
(43) Pub. Date: Dec. 25, 2014

(54) Inhibiting Salting Out of Diutan or Scleroglucan in Well Treatment

(71) Applicant: Halliburton Energy Services, Inc., Houston, TX (US)

(72) Inventor: Lalit Pandurang Salgaonkar, Pune (IN)

(21) Appl. No.: 13/924,857

(22) Filed: Jun. 24, 2013

(51) Int. Cl. C09K 8/90

(52) U.S. Cl. CPC C09K 8/90
USPC 507/211

(57) ABSTRACT

A fluid viscosified with diutan or scleroglucan is provided for use in a well, the fluid including: (i) water; (ii) one or more salts selected from the group consisting of alkali metal halide salts, alkaline earth metal halide salts, and any combination thereof; (iii) a viscosifier selected from the group consisting of diutan, a diutan derivative, scleroglucan, a scleroglucan derivative, and any combination thereof; and (iv) a delayed-release source of a weak acid; wherein the initial pH of the fluid is at least 6. In addition, a method of treating a portion of a well includes the steps of: (A) forming such a fluid; and (B) introducing the fluid into the portion of the well. The fluid has rheological properties that can be adapted, for example, to well treatments such as gravel packing at higher temperature and in higher density brines while avoiding salting out of the viscosifier.

### CROSS-REFERENCE TO RELATED APPLICATIONS

Not applicable.

### TECHNICAL FIELD

The inventions are in the field of producing crude oil or natural gas from subterranean formations. More specifically, the inventions generally relate to compositions and methods to inhibit the salting out of diutan or scleroglucan from viscosified carrier fluids at higher temperatures and higher brine densities while maintaining other performance parameters for viscosified fluids used in wells.

### BACKGROUND

Diutan has excellent viscosity retention at high temperatures in comparison to other polymeric rheology modifiers such as xanthan. The high viscosity and good thermal stability of diutan makes it a preferred choice in gravel packing fluid systems at higher temperatures. The concentration of diutan in the treatment fluid can be selected to provide good suspension of particulates such as sand or gravel under the design conditions downhole. After completion of the gravel packing job, a diutan gel can be broken completely, most commonly using acidic breakers.

Unfortunately, diutan is subject to a salting-out effect. A salting-out effect on a polymer is exhibited as precipitation or lump formation.

The salting-in and salting-out ability of the ions of various salts is described as per the Hofmeister series, which arises from the solubility properties of polymers in salt solutions. The Hofmeister series is described in U.S. Pat. No. 7,595,282 having for named inventors Bobby Burns, Richard W. Pauls, and Ian Robb, issued Sep. 29, 2009, which is incorporated herein by reference. In general, the salting-in and salting-out effect depends on the nature of the ions, mainly anions and to a lesser extent the cations. With respect to potassium salts, iodide shows the most effective salting-in and hence the least salting-out property. However, due to the high costs of iodide salts coupled with large volumes of treatment fluids required for a gravel packing job, this approach is not commercially feasible and hence not accepted.

U.S. Pat. No. 7,989,400 having for named inventors Richard W. Pauls and Ian D. Robb of Halliburton, issued Aug. 2, 2011, discloses methods for treating subterranean formations with diutan-based treatment fluids prepared in salts which exhibit salting-in effect at least as high as for bromide (as per the Hofmeister series). This is to help prevent the salting-out effect on diutan. U.S. Pat. No. 7,989,400 is incorporated by reference in its entirety.

In addition to the salting-in and salting-out characteristics of a salt on a polymeric material in solution, the salting-out effect on diutan in a salt solution is a cumulative effect of temperature, brine density, and pH.

At lower temperatures of less than about 82° C. (180° F.) when in lower brine densities (for example, less than about 10 ppg NaBr brine), diutan maintains its conformational stability even under acidic pH conditions (pH<3) and does not exhibit the salting-out phenomenon. However, at temperatures above about 82° C. (180° F.) when diutan in higher concentration brines (density equal to or greater than about 10 ppg NaBr brine), diutan exhibits a salting-out effect.

The salting-out effect on diutan is more pronounced under acidic conditions, especially when the pH is less than about 3. This makes the use of organic acids to break the viscosity of diutan-based fluids problematic as addition of an acid causes the polymer to salt-out of the fluid and the fluid loses its carrying capacity for a particulate.

This salting-out phenomenon has limited the temperature and brine density ranges in which diutan can be used in well treatments such as gravel packing. In spite of all the advantageous gravel carrying properties of diutan, however, the treatment fluids are limited in their applications, due to the salting-out effect especially at high temperature and high brine densities.

To address this salting-out issue, U.S. Pat. No. 7,846,877 having for named inventor Ian D. Robb, of Halliburton, issued Dec. 7, 2010, discloses a method of incorporation of urea as an additive to prevent salting-out effect on diutan. U.S. Pat. No. 7,846,877 is incorporated by reference in its entirety. However, this method has not found commercial acceptability and hence is not being widely used.

Under high temperature and high brine density conditions, the applicability of existing diutan-based fluids is limited. To cover these conditions, crosslinked xanthan fluids are required to be used for gravel packing applications. This approach too, is associated with certain drawbacks. If a chelating agent is present in the NaBr, it prevents the cross-linker from crosslinking the xanthan. Hence, for NaBr based brines to be used for cross-linked xanthan in gravel packing, the NaBr needs to be ordered from specific sources to ensure no chelating agent is included. This can be a logistical problem as it makes it difficult to change brine type and density to use the required clean NaBr on short notice. As diutan fluids are usually not crosslinked, special sources of NaBr free of any chelating agent is not required. In addition, where gravel packing jobs need to be performed at temperatures higher than 82° C. (180° F.), diutan-based fluids are preferred over xanthan-based fluids.

There has been a long-felt need for cost-effective diutan fluids and methods that solve the problem of salting out of diutan in brines at higher temperatures in well treatments, especially gravel packing.

### SUMMARY OF THE INVENTION

A fluid viscosified with diutan is provided for use in a well. The fluid includes: (i) water; (ii) one or more salts selected from the group consisting of alkali metal halide salts, alkaline earth metal halide salts, and any combination thereof; (iii) a viscosifier selected from the group consisting of diutan, a diutan derivative, scleroglucan, a scleroglucan derivative, and any combination thereof; and (iv) a delayed-release source of a weak acid.

According to another embodiment of the invention, a method of treating a portion of a well, the method comprising the steps of: (A) forming a fluid according to the invention; and (B) introducing the fluid into the portion of the well.

These and other aspects of the invention will be apparent to one skilled in the art upon reading the following detailed description. While the invention is susceptible to various modifications and alternative forms, specific embodiments thereof will be described in detail and shown by way of example. It should be understood, however, that it is not intended to limit the invention to the particular forms disclosed, but, on the contrary, the invention is to cover all modifications and alternatives falling within the scope of the invention as expressed in the appended claims.

### DETAILED DESCRIPTION OF PRESENTLY PREFERRED EMBODIMENTS AND BEST MODE

### Definitions and Usages

General Interpretation

The words or terms used herein have their plain, ordinary meaning in the field of this disclosure, except to the extent explicitly and clearly defined in this disclosure or unless the specific context otherwise requires a different meaning.

If there is any conflict in the usages of a word or term in this disclosure and one or more patent(s) or other documents that may be incorporated by reference, the definitions that are consistent with this specification should be adopted.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed. As used herein, the words “consisting essentially of,” and all grammatical variations thereof are intended to limit the scope of a claim to the specified materials or steps and those that do not materially affect the basic and novel characteristic(s) of the claimed invention.

The indefinite articles “a” or “an” mean one or more than one of the component, part, or step that the article introduces.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

It should be understood that algebraic variables and other scientific symbols used herein are selected arbitrarily or according to convention. Other algebraic variables can be used.

The control or controlling of a condition includes any one or more of maintaining, applying, or varying of the condition. For example, controlling the temperature of a substance can include heating, cooling, or thermally insulating the substance.

Oil and Gas Reservoirs

In the context of production from a well, “oil” and “gas” are understood to refer to crude oil and natural gas, respectively. Oil and gas are naturally occurring hydrocarbons in certain subterranean formations.

A “subterranean formation” is a body of rock that has sufficiently distinctive characteristics and is sufficiently continuous for geologists to describe, map, and name it.

A subterranean formation having a sufficient porosity and permeability to store and transmit fluids is sometimes referred to as a “reservoir.”

A subterranean formation containing oil or gas may be located under land or under the seabed off shore. Oil and gas reservoirs are typically located in the range of a few hundred feet (shallow reservoirs) to a few tens of thousands of feet (ultra-deep reservoirs) below the surface of the land or seabed.

Well Servicing and Fluids

To produce oil or gas from a reservoir, a wellbore is drilled into a subterranean formation, which may be the reservoir or adjacent to the reservoir. Typically, a wellbore of a well must be drilled hundreds or thousands of feet into the earth to reach a hydrocarbon-bearing formation.

Generally, well services include a wide variety of operations that may be performed in oil, gas, geothermal, or water wells, such as drilling, cementing, completion, and intervention. Well services are designed to facilitate or enhance the production of desirable fluids such as oil or gas from or through a subterranean formation. A well service usually involves introducing a fluid into a well.

Drilling, completion, and intervention operations can include various types of treatments that are commonly performed on a well or subterranean formation. For example, a treatment for fluid-loss control can be used during any of drilling, completion, and intervention operations. During completion or intervention, stimulation is a type of treatment performed to enhance or restore the productivity of oil and gas from a well. Stimulation treatments fall into two main groups: hydraulic fracturing and matrix treatments. Fracturing treatments are performed above the fracture pressure of the subterranean formation to create or extend a highly permeable flow path between the formation and the wellbore. Matrix treatments are performed below the fracture pressure of the formation. Other types of completion or intervention treatments can include, for example, gravel packing, consolidation, and controlling excessive water production.

Wells

A “well” includes a wellhead and at least one wellbore from the wellhead penetrating the earth. The “wellhead” is the surface termination of a wellbore, which surface may be on land or on a seabed.

A “well site” is the geographical location of a wellhead of a well. It may include related facilities, such as a tank battery, separators, compressor stations, heating or other equipment, and fluid pits. If offshore, a well site can include a platform.

The “wellbore” refers to the drilled hole, including any cased or uncased portions of the well or any other tubulars in the well. The “borehole” usually refers to the inside wellbore wall, that is, the rock surface or wall that bounds the drilled hole. A wellbore can have portions that are vertical, horizontal, or anything in between, and it can have portions that are straight, curved, or branched. As used herein, “uphole,” “downhole,” and similar terms are relative to the direction of the wellhead, regardless of whether a wellbore portion is vertical or horizontal.

A wellbore can be used as a production or injection wellbore. A production wellbore is used to produce hydrocarbons from the reservoir. An injection wellbore is used to inject a fluid, e.g., liquid water or steam, to drive oil or gas to a production wellbore.

As used herein, introducing “into a well” means introducing at least into and through the wellhead. According to various techniques known in the art, tubulars, equipment, tools, or fluids can be directed from the wellhead into any desired portion of the wellbore.

As used herein, a “fluid” broadly refers to any fluid adapted to be introduced into a well for any purpose. A fluid can be, for example, a drilling fluid, a setting composition, a treatment fluid, or a spacer fluid. If a fluid is to be used in a relatively small volume, for example less than about 100 barrels (about 4,200 US gallons or about 16 m³), it is sometimes referred to as a wash, dump, slug, or pill.

As used herein, the word “treatment” refers to any treatment for changing a condition of a portion of a wellbore or a subterranean formation adjacent a wellbore; however, the word “treatment” does not necessarily imply any particular treatment purpose. A treatment usually involves introducing a fluid for the treatment, in which case it may be referred to as a treatment fluid, into a well. As used herein, a “treatment fluid” is a fluid used in a treatment. The word “treatment” in the term “treatment fluid” does not necessarily imply any particular treatment or action by the fluid.

In the context of a well or wellbore, a “portion” or “interval” refers to any downhole portion or interval along the length of a wellbore.

A “zone” refers to an interval of rock along a wellbore that is differentiated from uphole and downhole zones based on hydrocarbon content or other features, such as permeability, composition, perforations or other fluid communication with the wellbore, faults, or fractures. A zone of a wellbore that penetrates a hydrocarbon-bearing zone that is capable of producing hydrocarbon is referred to as a “production zone.” A “treatment zone” refers to an interval of rock along a wellbore into which a fluid is directed to flow from the wellbore. As used herein, “into a treatment zone” means into and through the wellhead and, additionally, through the wellbore and into the treatment zone.

As used herein, a “downhole” fluid (or gel) is an in-situ fluid in a well, which may be the same as a fluid at the time it is introduced, or a fluid mixed with another fluid downhole, or a fluid in which chemical reactions are occurring or have occurred in-situ downhole.

Generally, the greater the depth of the formation, the higher the static temperature and pressure of the formation. Initially, the static pressure equals the initial pressure in the formation before production. After production begins, the static pressure approaches the average reservoir pressure.

A “design” refers to the estimate or measure of one or more parameters planned or expected for a particular fluid or stage of a well service or treatment. For example, a fluid can be designed to have components that provide a minimum density or viscosity for at least a specified time under expected downhole conditions. A well service may include design parameters such as fluid volume to be pumped, required pumping time for a treatment, or the shear conditions of the pumping.

The term “design temperature” refers to an estimate or measurement of the actual temperature at the downhole environment during the time of a treatment. For example, the design temperature for a well treatment takes into account not only the bottom hole static temperature (“BHST”), but also the effect of the temperature of the fluid on the BHST during treatment. The design temperature for a fluid is sometimes referred to as the bottom hole circulation temperature (“BHCT”). Because fluids may be considerably cooler than BHST, the difference between the two temperatures can be quite large. Ultimately, if left undisturbed a subterranean formation will return to the BHST.

Substances, Chemicals, and Derivatives

A substance can be a pure chemical or a mixture of two or more different chemicals. A pure chemical is a sample of matter that cannot be separated into simpler components without chemical change.

As used herein, unless the context otherwise requires, a “polymer” or “polymeric material” includes polymers, copolymers, terpolymers, etc. In addition, the term “copolymer” as used herein is not limited to the combination of polymers having two monomeric units, but includes any combination of monomeric units, for example, terpolymers, tetrapolymers, etc.

As used herein, “modified” or “derivative” means a chemical compound formed by a chemical process from a parent compound, wherein the chemical backbone skeleton of the parent compound is retained in the derivative. The chemical process preferably includes at most a few chemical reaction steps, and more preferably only one or two chemical reaction steps. As used herein, a “chemical reaction step” is a chemical reaction between two chemical reactant species to produce at least one chemically different species from the reactants (regardless of the number of transient chemical species that may be formed during the reaction). An example of a chemical step is a substitution reaction. Substitution on the reactive sites of a polymeric material may be partial or complete.

Phases and Physical States

As used herein, “phase” is used to refer to a substance having a chemical composition and physical state that is distinguishable from an adjacent phase of a substance having a different chemical composition or a different physical state.

As used herein, if not other otherwise specifically stated, the physical state or phase of a substance (or mixture of substances) and other physical properties are determined at a temperature of 77° F. (25° C.) and a pressure of 1 atmosphere (Standard Laboratory Conditions) without applied shear.

Particles and Particulates

As used herein, a “particle” refers to a body having a finite mass and sufficient cohesion such that it can be considered as an entity but having relatively small dimensions. A particle can be of any size ranging from molecular scale to macroscopic, depending on context.

A particle can be in any physical state. For example, a particle of a substance in a solid state can be as small as a few molecules on the scale of nanometers up to a large particle on the scale of a few millimeters, such as large grains of sand. Similarly, a particle of a substance in a liquid state can be as small as a few molecules on the scale of nanometers up to a large drop on the scale of a few millimeters. A particle of a substance in a gas state is a single atom or molecule that is separated from other atoms or molecules such that intermolecular attractions have relatively little effect on their respective motions.

As used herein, particulate or particulate material refers to matter in the physical form of distinct particles in a solid or liquid state (which means such an association of a few atoms or molecules). As used herein, a particulate is a grouping of particles having similar chemical composition and particle size ranges anywhere in the range of about 0.5 micrometer (500 nm), e.g., microscopic clay particles, to about 3 millimeters, e.g., large grains of sand.

A particulate can be of solid or liquid particles. As used herein, however, unless the context otherwise requires, particulate refers to a solid particulate. Of course, a solid particulate is a particulate of particles that are in the solid physical state, that is, the constituent atoms, ions, or molecules are sufficiently restricted in their relative movement to result in a fixed shape for each of the particles.

It should be understood that the terms “particle” and “particulate,” includes all known shapes of particles including substantially rounded, spherical, oblong, ellipsoid, rod-like, fiber, polyhedral (such as cubic materials), etc., and mixtures thereof. For example, the term “particulate” as used herein is intended to include solid particles having the physical shape of platelets, shavings, flakes, ribbons, rods, strips, spheroids, toroids, pellets, tablets or any other physical shape.

A particulate will have a particle size distribution (“PSD”). As used herein, “the size” of a particulate can be determined by methods known to persons skilled in the art.

One way to measure the approximate particle size distribution of a solid particulate is with graded screens. A solid particulate material will pass through some specific mesh (that is, have a maximum size; larger pieces will not fit through this mesh) but will be retained by some specific tighter mesh (that is, a minimum size; pieces smaller than this will pass through the mesh). This type of description establishes a range of particle sizes. A “+” before the mesh size indicates the particles are retained by the sieve, while a “−” before the mesh size indicates the particles pass through the sieve. For example, −70/+140 means that 90% or more of the particles will have mesh sizes between the two values.

Particulate materials are sometimes described by a single mesh size, for example, 100 U.S. Standard mesh. If not otherwise stated, a reference to a single particle size means about the mid-point of the industry-accepted mesh size range for the particulate.

Hydratability or Solubility

As referred to herein, “hydratable” means capable of being hydrated by contacting the hydratable agent with water. Regarding a hydratable agent that includes a polymer, this means, among other things, to associate sites on the polymer with water molecules and to unravel and extend the polymer chain in the water.

A substance is considered to be “soluble” in a liquid if at least 10 grams of the substance can be hydrated or dissolved in one liter of the liquid when tested at 77° F. and 1 atmosphere pressure for 2 hours, considered to be “insoluble” if less than 1 gram per liter, and considered to be “sparingly soluble” for intermediate solubility values.

As will be appreciated by a person of skill in the art, the hydratability, dispersibility, or solubility of a substance in water can be dependent on the salinity, pH, or other substances in the water. Accordingly, the salinity, pH, and additive selection of the water can be modified to facilitate the hydratability, dispersibility, or solubility of a substance in aqueous solution. To the extent not specified, the hydratability, dispersibility, or solubility of a substance in water is determined in deionized water, at neutral pH, and without any other additives.

The “source” of a chemical species in a solution or in a fluid composition can be a material or substance that is itself the chemical species, or that makes the chemical species chemically available immediately, or it can be a material or substance that gradually or later releases the chemical species to become chemically available in the solution or the fluid.

Fluids

A fluid can be a homogeneous or heterogeneous. In general, a fluid is an amorphous substance that is or has a continuous phase of particles that are smaller than about 1 micrometer that tends to flow and to conform to the outline of its container.

Every fluid inherently has at least a continuous phase. A fluid can have more than one phase. The continuous phase of a treatment fluid is a liquid under Standard Laboratory Conditions. For example, a fluid can be in the form of a suspension (larger solid particles dispersed in a liquid phase), an emulsion (liquid particles dispersed in another liquid phase), or a foam (a gas phase dispersed in a liquid phase).

As used herein, a “water-based” fluid means that water or an aqueous solution is the dominant material of the continuous phase, that is, greater than 50% by weight, of the continuous phase of the fluid based on the combined weight of water and any other solvents in the phase (that is, excluding the weight of any dissolved solids).

Apparent Viscosity of a Fluid

Viscosity is a measure of the resistance of a fluid to flow. In everyday terms, viscosity is “thickness” or “internal friction.” Therefore, pure water is “thin,” having a relatively low viscosity whereas honey is “thick,” having a relatively higher viscosity. Put simply, the less viscous the fluid is, the greater its ease of movement (fluidity). More precisely, viscosity is defined as the ratio of shear stress to shear rate.

A Newtonian fluid (named after Isaac Newton) is a fluid for which stress versus strain rate curve is linear and passes through the origin. The constant of proportionality is known as the viscosity. Examples of Newtonian fluids include water and most gases. Newton's law of viscosity is an approximation that holds for some substances but not others.

Non-Newtonian fluids exhibit a more complicated relationship between shear stress and velocity gradient (i.e., shear rate) than simple linearity. Therefore, there exist a number of forms of non-Newtonian fluids. Shear thickening fluids have an apparent viscosity that increases with increasing the rate of shear. Shear thinning fluids have a viscosity that decreases with increasing rate of shear. Thixotropic fluids become less viscous over time at a constant shear rate. Rheopectic fluids become more viscous over time at a constant shear rate. A Bingham plastic is a material that behaves as a solid at low stresses but flows as a viscous fluid at high yield stresses.

Most fluids are non-Newtonian fluids. Accordingly, the apparent viscosity of a fluid applies only under a particular set of conditions including shear stress versus shear rate, which must be specified or understood from the context. As used herein, a reference to viscosity is actually a reference to an apparent viscosity. Apparent viscosity is commonly expressed in units of mPa·s or centipoise (cP), which are equivalent.

Like other physical properties, the viscosity of a Newtonian fluid or the apparent viscosity of a non-Newtonian fluid may be highly dependent on the physical conditions, primarily temperature and pressure.

Gels and Deformation

The physical state of a gel is formed by a network of interconnected molecules, such as a crosslinked polymer or a network of micelles. The network gives a gel phase its structure and an apparent yield point. At the molecular level, a gel is a dispersion in which both the network of molecules is continuous and the liquid is continuous. A gel is sometimes considered as a single phase.

Technically, a “gel” is a semi-solid, jelly-like physical state or phase that can have properties ranging from soft and weak to hard and tough. Shearing stresses below a certain finite value fail to produce permanent deformation. The minimum shear stress which will produce permanent deformation is referred to as the shear strength or gel strength of the gel.

In the oil and gas industry, however, the term “gel” may be used to refer to any fluid having a viscosity-increasing agent, regardless of whether it is a viscous fluid or meets the technical definition for the physical state of a gel. A “base gel” is a term used in the field for a fluid that includes a viscosity-increasing agent, such as guar, but that excludes crosslinking agents. Typically, a base gel is mixed with another fluid containing a crosslinker, wherein the mixture is adapted to form a crosslinked gel. Similarly, a “crosslinked gel” may refer to a substance having a viscosity-increasing agent that is crosslinked, regardless of whether it is a viscous fluid or meets the technical definition for the physical state of a gel.

As used herein, a substance referred to as a “gel” is subsumed by the concept of “fluid” if it is a pumpable fluid.

Viscosity and Gel Measurements

There are numerous ways of measuring and modeling viscous properties, and new developments continue to be made. The methods depend on the type of fluid for which viscosity is being measured. A typical method for quality assurance or quality control (QA/QC) purposes uses a couette type device, such as a FANN™ Model 35 or Model 50 viscometer or a CHANDLER 5550 HPHT viscometer. Such a viscometer measures viscosity as a function of time, temperature, and shear rate. The viscosity-measuring instrument can be calibrated using standard viscosity silicone oils or other standard viscosity fluids.

Due to the geometry of most common viscosity-measuring devices, however, solid particulate, especially if larger than silt (larger than 74 micron), would interfere with the measurement on some types of measuring devices. Therefore, the viscosity of a fluid containing such solid particulate is usually inferred and estimated by measuring the viscosity of a test fluid that is similar to the fracturing fluid without any proppant or gravel that would otherwise be included. However, as suspended particles (which can be solid, gel, liquid, or gaseous bubbles) usually affect the viscosity of a fluid, the actual viscosity of a suspension is usually somewhat different from that of the continuous phase.

As used herein, to be considered to be suitable for use as a carrier fluid for applications such as gravel packing, it is believed that a linear or crosslinked gel needs to exhibit sufficient viscoelastic properties, e.g., at least about 25 mPa·s (cP) at a shear rate of 511 sec⁻¹.

General Measurement

Unless otherwise specified or unless the context otherwise clearly requires, any ratio or percentage means by weight.

Unless otherwise specified or unless the context otherwise clearly requires, the phrase “by weight of the water” means the weight of the water of an aqueous phase of the fluid without the weight of any viscosity-increasing agent, dissolved salt, suspended particulate, or other materials or additives that may be present in the water.

If there is any difference between U.S. or Imperial units, U.S. units are intended. For example, “GPT” or “gal/Mgal” means U.S. gallons per thousand U.S. gallons and “ppt” means pounds per thousand U.S. gallons.

Unless otherwise specified, mesh sizes are in U.S. Standard Mesh.

The micrometer (μm) may sometimes be referred to herein as a micron.

The conversion between pound per gallon (lb/gal or ppg) and kilogram per cubic meter (kg/m³) is: 1 lb/gal=(0.4536 kg/lb)×(gal/0.003785 m³)=120 kg/m³.

The conversion between pound per thousand gallons (lb/Mgal) and kilogram per cubic meter (kg/m³) is: 1 lb/Mgal=(0.4536 kg/lb)×(Mgal/3.785 m³)=0.12 kg/m³.

### General Approach

A delayed-release source of a weak acid is selected and in a concentration that allows a fluid viscosified with diutan to be broken with acid, but the initial pH of the aqueous phase is preferably above about 6. After liberating the acid, the pH may fall, for example, as low as about 2. By then, however, the process of carrying the particulate down hole is complete. The initial carrying capacity helps carry a particulate for a treatment, then the acid is released to break the diutan downhole. This concept avoids the pH of the fluid from having an initial pH at a value where salting-out is seen.

According to an embodiment, a fluid viscosified with diutan is provided for use in a well. The fluid includes: (i) water; (ii) one or more salts selected from the group consisting of alkali metal halide salts, alkaline earth metal halide salts, and any combination thereof; (iii) a viscosifier selected from the group consisting of diutan, a diutan derivative, scleroglucan, a scleroglucan derivative, and any combination thereof; and (iv) a delayed-release source of a weak acid. Preferably, the initial pH of the water of the fluid is at least 6. More preferably, the initial pH is in a range of 6 to 8. Most preferably, the initial pH of the fluid is in the range of 6 to 7. Preferably, the one or more salts are in at least a sufficient concentration dissolved in the water such that the solution has a density of at least 10 ppg.

According to another embodiment of the invention, a method of treating a portion of a well, the method comprising the steps of: (A) forming a fluid according to the invention; and (B) introducing the fluid into the portion of the well.

The present invention provides a simple and effective way to avoid the salting out of diutan or scleroglucan in higher density brines or at higher temperatures. The acid precursor provides a dual function of mitigating salting-out and at the same time generating acid in-situ to finally break the diutan gel.

In an embodiment, the present invention provides compositions and methods to prevent the salting-out effect on diutan at high brine density (equal to or greater than about 10 ppg NaBr) and high temperature equal to or greater than about 82° C. (180° F.).

This would allow a diutan fluid according to the invention to be used in a gravel packing operation. Once the gravel packing operation is completed, the acid precursors would generate acid in-situ to effect breaking of the gel.

The present invention provides fluids and methods to overcome the issue of salting out of diutan or scleroglucan at high temperature and high brine densities. This will increase the applications for fluids viscosified with diutan or scleroglucan to include higher density fluids and hence, among other things, allow diutan to be used in more gravel packing treatments and at higher temperatures.

### Carrier Fluid for Particulate

A fluid according to the invention can be used for various purposes. In an embodiment, the fluid can be used and adapted to be a carrier fluid for a particulate.

For example, a proppant used in fracturing or a gravel used in gravel packing may have a much different density than the carrier fluid. For example, sand has a specific gravity of about 2.7, whereas water has a specific gravity of 1.0 at Standard Laboratory Conditions of temperature and pressure. A proppant or gravel having a different density than water will tend to separate from water very rapidly.

As many fluids for use in a well are water-based, partly for the purpose of helping to suspend particulate of higher density, and for other reasons known in the art, the density of the fluid used in a well can be increased by including highly water-soluble salts in the water, such as potassium chloride. However, increasing the density of a fluid will rarely be sufficient to match the density of the particulate.

Increasing the viscosity of a fluid can help prevent a particulate having a different specific gravity than a surrounding phase of the fluid from quickly separating out of the fluid.

A viscosity-increasing agent can be used to increase the ability of a fluid to suspend and carry a particulate material in a fluid. A viscosity-increasing agent can be used for other purposes, such as matrix diversion, conformance control, or friction reduction.

A viscosity-increasing agent is sometimes referred to in the art as a viscosifying agent, viscosifier, thickener, gelling agent, or suspending agent. In general, any of these refers to an agent that includes at least the characteristic of increasing the viscosity of a fluid in which it is dispersed or dissolved. There are several kinds of viscosity-increasing agents or techniques for increasing the viscosity of a fluid.

In general, because of the high volume of fluids typically used in a fracturing or gravel packing operation, it is desirable to efficiently increase the viscosity of fracturing fluids to the desired viscosity using as little viscosity-increasing agent as possible. In addition, relatively inexpensive materials are preferred. Being able to use only a small concentration of the viscosity-increasing agent requires a lesser concentration of the viscosity-increasing agent in order to achieve the desired fluid viscosity.

Certain kinds of polymers can be used to increase the viscosity of a fluid. In general, the purpose of using a polymer is to increase the ability of the fluid to suspend and carry a particulate material. Polymers for increasing the viscosity of a fluid are preferably soluble in the external phase of a fluid. Polymers for increasing the viscosity of a fluid can be naturally occurring polymers such as polysaccharides, derivatives of naturally occurring polymers, or synthetic polymers.

As will be appreciated by a person of skill in the art, the dispersibility or solubility in water of a certain kind of polymeric material may be dependent on the salinity or pH of the water. Accordingly, the salinity or pH of the water can be modified to facilitate the dispersibility or solubility of the water-soluble polymer. In some cases, the water-soluble polymer can be mixed with a surfactant to facilitate its dispersibility or solubility in the water or salt solution utilized.

A polymer can be classified as being single chain or multi chain, based on its solution structure in aqueous liquid media. Examples of single-chain polysaccharides that are commonly used in the oilfield industry include guar, guar derivatives, and cellulose derivatives. Guar polymer, which is derived from the beans of a guar plant, is referred to chemically as a galactomannan gum. Examples of multi-chain polysaccharides include xanthan, diutan, and scleroglucan, and derivatives of any of these. Without being limited by any theory, it is currently believed that the multi-chain polysaccharides have a solution structure similar to a helix or are otherwise intertwined.

### Diutan

Diutan gum (commonly referred to simply as diutan) is a multi-chain polysaccharide that is sometimes used to increase viscosity in fluids.

In general, diutan is a polysaccharide which may be prepared by fermentation of a strain of sphingomonas. Diutan may also be referred to as a polysaccharide designated S-657 or S-8 in some literature. Its structure has been elucidated as having a repeat unit of a hexasaccharide with a tetrasaccharide repeat unit in the backbone that includes glucose and rhamnose units and a di-rhamnose side chain. Details of the diutan gum structure may be found in an article by Diltz et al., “Location of O-acetyl Groups in S-657 Using the Reductive-Cleavage Method,” Carbohydrate Research, Vol. 331, pp. 265-270 (2001). Details of preparing diutan gum may be found in U.S. Pat. No. 5,175,278, which is incorporated by reference. It is believed to have thickening, suspending, and stabilizing properties in aqueous or non-aqueous solutions.

Clarified diutan refers to a diutan that has improved turbidity or filtration properties as compared to non-clarified diutan. In some embodiments, suitable clarified diutans may have been treated with enzymes or the like to remove residual cellular structures, such as cell walls. In some embodiments, suitable clarified diutan may be produced from genetically modified or bioengineered strains of bacteria or other strains of bacteria that allow the clarified diutan to have improved functional properties such as filterability, turbidity, etc. The diutan for use in the present invention can be a clarified diutan.

A suitable source of a diutan is “GEOVIS XT,” which is commercially available from Kelco Oil Field Group, Houston, Tex. Other examples of suitable sources of a diutan may include those disclosed in U.S. Pat. No. 5,175,278 and U.S. Patent Publication Nos. 2006/0121578, 2006/0199201, 2006/0166836, 2006/0166837, and 2006/0178276, which are herein incorporated by reference.

A fluid viscosified with a diutan can enable a substantial amount of design flexibility for a number of applications that would benefit using a shear-thinning, low-damage fluid system including, for example, gravel packing, fluid-loss control, and friction pressure reduction.

A fluid viscosified with a diutan can enable a simple mixing procedure and rapid viscosity development in a number of water-based fluids including for example, freshwater, potassium or sodium chloride brines, and sodium bromide brines. The polymer can be rapidly dispersed in an aqueous phase without going through a complex mixing protocol or an extended hydration period. Its ease of mixing and rapid hydration apply to seawater and mono-valent brines used in completion operations.

A fluid viscosified with diutan can provide excellent particulate suspension under static conditions at temperatures up to about 270° F. (132° C.). It is a shear thinning fluid that has relatively low viscosity at high shear rates and high viscosity at low shear rates, which is useful in many types of treatment applications.

Because such fluids have high viscosity under low shear conditions, it can be useful to suspend particulates similar to a fluid viscosified with a cross-linked polymer. In addition, the high viscosities under low shear attained with these polymer loadings can be used to help control fluid losses during workover and completion operations with reduced damage to the formation.

At lower polymer concentrations, a fluid with diutan can produce a “slick water” or “slick brine” consistency to help reduce pumping friction pressures.

The diutan can be provided in any form that is suitable for the particular treatment fluid or application. For example, the diutan can be provided as a liquid, gel, suspension, or solid additive that is incorporated into a treatment fluid.

The diutan can be used in any appropriate concentration to provide the desired fluid rheology. For example, diutan can be present in the fluids in a concentration in the range of from about 0.01% to about 5% by weight of the continuous aqueous phase. For example, the concentration of viscosity-increasing agent used in the treatment fluids may vary from about 0.25 pounds per 1,000 gallons of treatment fluid (“lbs/Mgal”) to about 200 lbs/Mgal. In other embodiments, the concentration of viscosity-increasing agent included in the treatment fluids may vary from about 10 lbs/Mgal to about 80 lbs/Mgal. In another embodiment, about 20 pounds to about 70 pounds (lbs) of water-soluble polymer per 1,000 gallons (Mgal) of water (equivalent to about 2.4 g/L to about 8.4 g/L).

In an embodiment, the diutan is in at least a sufficient concentration in the fluid such that the fluid has an apparent viscosity of at least about 25 mPa·s (cP) at a shear rate of 511 sec⁻¹ upon hydration of the diutan. In an embodiment, the diutan is in at least a sufficient concentration in the fluid such that the fluid forms a lipping gel upon hydration of the diutan.

### Scleroglucan

Scleroglucan is a neutral fungal polysaccharide. Scleroglucan is a hydrophilic polymer, which is believed to have a tendency to thicken and stabilize water-based systems by conferring on them a relatively high viscosity, generally higher than that obtained in the case of xanthan, for example, at temperatures at or above about 200° F. (93° C.), for identical concentrations of active compounds. Scleroglucan also appears to be more resistant to pH and temperature changes than xanthan, and therefore, may impart more stable viscosity in such conditions. In certain aspects, the viscosity of a scleroglucan fluid may be virtually independent of pH between a pH of about 1 and about 12.5 up to a temperature limit of about 270° F. (132° C.). Generally, the main backbone polymer chain of scleroglucan comprises (1→3)β-D-glucopyranosyl units with a single β-D-glucopyranosyl group attached to every third unit on the backbone. Scleroglucan is thought to be resistant to degradation, even at high temperatures such as those at or above about 200° F. (93° C.), even after, for example, 500 days in seawater. Dilute solutions (e.g., about 0.5%) may be shear thinning and stable to at least 250° F. (121° C.). Note that these solutions are not acidic. These viscosities illustrate, among other things, scleroglucan's suitability for viscosifying fluids.

In embodiments wherein the gelling agent of the present invention comprises scleroglucan, one may include about 10 to about 200 lb/Mgal scleroglucan.

### Salts and Saltine Out in Carrier Fluid

Pure water has a density of about 8.3 ppg. It is often desirable to use a treatment in having a higher density, which can be helpful in controlling the well. Highly water-soluble inorganic salts dissolved in water to form a dense aqueous phase can be used in treatment fluids to increase the overall density of a fluid used in a well.

The performance of a diutan is significantly affected by, among other things, the salt content in the fluid, and, unusually for a polysaccharide, salt type. The performance of a scleroglucan can be similarly affected.

A discussion will now follow on the Hofmeister series, which arises from the solubility properties of polymers in salt solutions. An example of this effect is shown regarding the temperature at which a 0.5% solution of poly(ethylene oxide) or “PEO” having a molecular weight 4×10⁶ becomes insoluble in various salts, where salt concentration is measured in moles of salt per liter. Bailey and Callard, J. Applied Polymer Sci., 1959; vol 1; p. 56.

The salting-in and salting-out effect depends on the nature of the ions, mainly anions and to a lesser extent, cations, involved. Referring to the Table 1 below, the most effective salting-out anions progress, increasingly, to the left of the table. The salting-out effect, or ability to precipitate PEO, is usually found for proteins and hydrophobic polymers, but not for polysaccharides like xanthan or guar. The salting-in effect of certain salts with diutan provides a method of controlling the rheology of a diutan-containing treatment fluid at temperatures above 80° C. With respect to the potassium salts, for example, the order of decreasing salting-out effect is SO₄⁼˜CO₃⁼>OH⁻>F⁻>Br⁻>I⁻. Table 1 illustrates the most effective salting-in anions progressing, increasingly, to the right of the table. Thus, “salting-in” effect, or ability to solubilize PEO, refers to an increase in solubility on the addition of salt.

TABLE 1
Effect of Salts on Temperature of Precipitation of PEO in Water
← Increasing precipitation, or “salting-out” effect
Increasing chaotropic, or “salting-in” effect →

Anions: PO₄³⁻ > SO₄²⁻ > HCOO⁻ > CH₃COO⁻ >
Cl⁻ > NO₃⁻ > Br⁻ > ClO₄⁻ > I⁻ > SCN⁻

As suggested by its name, the “cloud point” is the temperature at which a polymer in solution, such as a 0.5% solution of PEO will become insoluble (indicated by the change of the solution from clear to cloudy). In pure water, the temperature at which a 0.5% solution of PEO will become insoluble is about 98° C. (208° F.). On the addition of various salts, this temperature is lowered. The lower the cloud point for the salt, the less soluble the PEO is in the solution. The Hofmeister series is well known, and reference can be made to, for example, Bailey and Callard, J. Applied Polymer Sci., 1959; vol 1; p. 56; P. von Hippel and T. Schleich, Structure & Stability of Biological Macromolecules, Marcel Dekker New York, 1969 Chapter 6; and M. Salomaki et al, Langmuir (2004) 20, 3679.

Preferably, the salts of the Hofmeister series for use in this invention are selected from the group consisting of bromides; other salts having a higher salting-in effect than bromide according to the Hofmeister series as measured by the salt's effect on the cloud point of poly(ethylene oxide) that has a molecular weight of 4×10⁶; and any combination in any proportion thereof. Also within the scope of the invention are anions with a salting-in effect according to the Hofmeister series such as iodide, thiocyanate and perchlorate, as well as mixtures of the salts with different anions or cations.

The amount of salt in the solution is selected to be sufficient to provide the desired density in the treatment fluid. In one aspect of the invention, a sufficient amount of salt is added to the treatment fluid to increase the density of the treatment fluid to at least 8.5 lb/gal, wherein at least 50% by weight of the salt is selected from the group consisting of: (i) bromide salts, (ii) non-bromide salts having a higher salting-in effect than bromide according to the Hofmeister series as measured by the salt's effect on the cloud point of poly(ethylene oxide) that has a molecular weight of 4×10⁶, and (iii) any combination in any proportion thereof. Preferably, the salt comprises at least 50% by weight of salt selected from the group consisting of potassium bromide, sodium bromide, ammonium bromide, zinc bromide, and calcium bromide.

Preferably, less than 50% by weight of the salt is selected from salts such as nitrates, chlorides, formates, and sulfates, which tend to be salting-out salts.

More preferably and in an embodiment, the concentration of the one or more bromide salts or salts having a higher salting-in effect according to the Hofmeister series above is at least sufficient to form an aqueous phase having a density greater than 10 ppg. Most preferably and in an embodiment, the concentration of the one or more such salts is at least sufficient to form an aqueous phase having a density greater than about 11 ppg.

### Delayed-Release Source of Weak Acid

As stated above, a delayed-release source of a weak acid is selected and in a concentration that allows a fluid viscosified with a diutan or a scleroglucan to be broken with acid, but the initial pH of the aqueous phase is preferably above about 6. This concept avoids the pH of the fluid from falling to a value where salting out of a diutan or scleroglucan is seen.

pH and Acids

The pH value represents the acidity of a solution. The potential of hydrogen (pH) is defined as the negative logarithm to the base 10 of the hydrogen concentration, represented as [H⁺] in moles/liter.

pH=−log₁₀ [H⁺]

Mineral acids tend to dissociate in water more easily than organic acids, to produce H⁺ ions and decrease the pH of the solution. Organic acids tend to dissociate more slowly than mineral acids and less completely.

Relative acid strengths for Bronsted-Lowry acids are expressed by the dissociation constant (pKa). A given acid will give up its proton to the base of an acid with a higher pKa value. The bases of a given acid will deprotonate an acid with a lower pKa value. In case there is more than one acid functionality for a chemical, “pKa(1)” makes it clear that the dissociation constant relates to the first dissociation.

The pKa of acids plays important role in above activities as shown in Table 2.

TABLE 2
Acid Strength and pKa

| | Acid | Base | pKa(1) |
|---|---|---|---|
| Strong Acids | HCIO₄ | CIO₄⁻ | −10 |
| In Water | HI | I⁻ | −10 |
| | H₂SO₄ | HSO₄⁻ | −10 |
| | HBr | Br⁻ | −9 |
| | HCl | Cl⁻ | −7 |
| | HNO₃ | NO₃⁻ | −1.4 |
| | H₃O⁺ | H₂O | −1.74 |
| Weak Acids | CCI₃CO₂H | CCI₃CO₂⁻ | 0.52 |
| In Water | HSO₄⁻ | SO₄⁻² | 1.99 |
| | H₃PO₄ | H₂PO₄⁻ | 2.12 |
| | CH₂CICO₂H | CH₂CICO₂⁻ | 2.85 |
| | HF | F⁻ | 3.17 |
| | HNO₂ | NO₂⁻ | 3.3 |
| | HCO₂H (formic acid) | HCO₂⁻ | 3.75 |
| | C₃H₅O₃H (lactic acid) | C₃H₅O₃⁻ | 3.86 |
| | CH₃CO₂H (acetic acid) | CH₃CO₂⁻ | 4.75 |
| | CH₃CH₂COOH | CH₃CH₂CO₂⁻ | 4.87 |
| | (propanoic) | | |
| | C₅H₅NH⁺ | C₅H₅N | 5.25 |
| | H₂CO₃ | HCO₃⁻ | 6.35 |
| | H₂S | HS⁻ | 7.0 |
| | NH₄⁺ | NH₃ | 9.24 |
| | HCO₃⁻ | CO₃⁻² | 10.33 |
| | CH₃NH₃⁺ | CH₃NH₂ | 10.56 |
| | H₂O | OH⁻ | 15.74 |

Water (H₂O) is the base of the hydronium ion, H₃O⁺, which has a pKa −1.74. An acid having a pKa less than that of hydronium ion, pKa −1.74, is considered a strong acid.

For example, hydrochloric acid (HCl) has a pKa −7, which is smaller than the pKa of the hydronium ion, pKa −1.74. This means that HCl will give up its protons to water essentially completely to form the H₃O⁺ cation. For this reason, HCl is classified as a strong acid in water. One can assume that all of the HCl in a water solution is 100% dissociated, meaning that both the hydronium ion concentration and the chloride ion concentration correspond directly to the amount of added HCl.

Acetic acid (CH₃CO₂H) has a pKa of 4.75, greater than that of the hydronium ion, but less than that of water itself, 15.74. This means that acetic acid can dissociate in water, but only to a small extent. Thus, acetic acid is classified as a weak acid.

Weak Acid Precursors

Preferably and in an embodiment, the weak acid is selected for having a pKa(1) in the range of about 2.5 to about 5.5. More preferably, the weak acid has a pKa(1) in the range of about 3 to about 5. Most preferably, the weak acid is selected from the group consisting of: formic acid, acetic acid, lactic acid, and any combination thereof.

Preferably, the delayed-release source of the weak acid is in at least a sufficient concentration to release at least a sufficient concentration of the weak acid to break the viscosity of the fluid.

The delayed-release source is preferably selected for releasing essentially all of the weak acid into the fluid in less than 5 days under the design conditions of a treatment of a portion of a well.

An example of a delayed-release source of a weak acid is a chemical compound that hydrolyzes in water to produce the weak acid. The rate of hydrolysis will depend on the particular chemical compound that is the acid precursor and the design temperature.

Preferably and in an embodiment, the delayed-release source of the weak acid is selected from the group consisting of: esters of formic acid, acetic acid, or lactic acid, polylactides, diethylene glycol diformate, and triisopropyl orthoformate, and any combination thereof.

An example of a suitable ester of lactic acid is lactide, which is a cyclic diester of lactic acid. Lactide hydrolyses slowly in water to produce lactic acid. Of course, the rate of hydrolysis increases with increasing temperature. Such an acid precursor can avoid the problem of salting out of the diutan gelling agent from the fluid and at the same time generate acid in-situ to finally break the polymer.

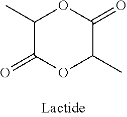

Another example of a suitable acid precursor for use according to the invention is triisopropyl orthoformate, which can be emulsified in a fluid according to the invention and will undergo hydrolysis to generate formic acid in-situ.

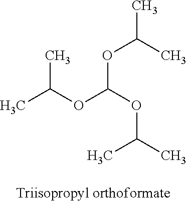

Preferably and in an embodiment, the aqueous phase of the fluid has an initial pH greater than about 6. More preferably, the aqueous phase of the fluid has an initial pH in the range of about 6 to about 8.

Preferably and in an embodiment, the aqueous phase of the fluid does not fall below about 3 after it is introduced into a portion of the well.

It is important to note that the disclosed concept of using acid precursor is a method to avoid salting out of the diutan polymer in gravel packing carrier fluid applications by delaying the release of acid during gravel packing operation. Optimization of the acid precursor concentration can achieve final fluid breaks in the desired time frame in the range of about 2 days to 5 days.

### Fluid Examples

To facilitate a better understanding of the present invention, the following examples of certain aspects of some embodiments are given. In no way should the following examples be read to limit, or define, the entire scope of the invention.

A gel stability study of diutan gels was performed at a high gel loading of 60 lb/Mgal of diutan and with a high brine density of 12.0 ppg NaBr. Experimental results with ethyl lactate as an example of an acid precursor compared to using formic acid have provided good results.

Diutan was hydrated as follows. The brine to be used as the base fluid was filtered using WHATMAN™ 50 filter paper. 980 ml of base fluid was measured out and added to a blender jar. The blender speed was set such that a vortex of about 1-inch depth was formed, which reduces air entrapment. Broad spectrum biocides (0.036 g/L) were added. Then 1.44 g of chelating citrate salt was added to the base fluid in the blender to sequester any free iron that may interfere with the proper texture development of the gel. The blender speed was increased to as close to maximum as possible avoiding air entrapment. Then the required amount of diutan was slowly added into the vortex. The fluid was blended for at least 10 minutes and as long as required to mix the dry powder into the base fluid, but to avoid the beating of air into the gel. By this point, the gel became thick. As soon as the vortex in the thickening gel disappeared due to the thickening, the blender was turned off and the gel was allowed to stand static for one hour hydration time. The gel was then ready for further processing by high speed blender shearing and filtration.

After hydration of the diutan, 20 gal/Mgal sulfonated derivative of benzene, oxybis-, tetrapropylene was added as a non-emulsifier.

Experimental results with ethyl lactate as an example of an acid precursor compared to using formic acid provided good results at 93° C. (200° F.), as shown in Table 3.

TABLE 3
Experimental Results

| | Test # | |
|---|---|---|
| | 1 | 2 |
| Temperature | 93° C. (200° F.) | 93° C. (200° F.) |
| Brine and density | 12.0 ppg NaBr | 12.0 ppg NaBr |
| Diutan loading | 60 lb/Mgal | 60 lb/Mgal |
| Formic acid (95%) | 6.0 ml/l (6.0 gal/Mgal) | None |
| Ethyl Lactate | None | 8.8 ml/l (8.8 gal/Mgal) |
| (100%) | | |
| Observations | Salting out | No lumping or salting out |

The concentration of ethyl lactate (8.8 ml/1) in test #2 releases 7.0 g of lactic acid. This was equivalent to the concentration of formic acid used in test #1. The pKa of formic acid and lactic acid are about the same such that they have similar acidity.

Ethyl lactate is safe to handle in the field. The boiling point of ethyl lactate is 151-155° C. (304-311° F.), whereas the boing point of formic acid is 100.8° C. (213° F.) and is a pungent smelling liquid. Ethyl lactate is known as an acid precursor for use in the temperature range of 185° F. (85° C.) to 266° F. (130° C.).

### Examples of Solid Particulate

Diutan can be used to viscosify treatment fluids for various applications, including without limitation, carrying a solid particulate into a portion of a well. A solid particulate can be selected for various purposes, such as being proppant in a hydraulic fracturing operation or for being gravel in a gravel packing operation.

Proppant for Hydraulic Fracturing

A newly-created or newly-extended fracture will tend to close together after the pumping of the fracturing fluid is stopped. To prevent the fracture from closing, a material is usually placed in the fracture to keep the fracture propped open and to provide higher fluid conductivity than the matrix of the formation. A material used for this purpose is referred to as a proppant.

A proppant is in the form of a solid particulate, which can be suspended in the fracturing fluid, carried downhole, and deposited in the fracture to form a proppant pack. The proppant pack props the fracture in an open condition while allowing fluid flow through the permeability of the pack. The proppant pack in the fracture provides a higher-permeability flow path for the oil or gas to reach the wellbore compared to the permeability of the matrix of the surrounding subterranean formation. This higher-permeability flow path increases oil and gas production from the subterranean formation.

A particulate for use as a proppant is usually selected based on the characteristics of size range, crush strength, and solid stability in the types of fluids that are encountered or used in wells. Preferably, a proppant should not melt, dissolve, or otherwise degrade from the solid state under the downhole conditions.

The proppant is selected to be an appropriate size to prop open the fracture and bridge the fracture width expected to be created by the fracturing conditions and the fracturing fluid. If the proppant is too large, it will not easily pass into a fracture and will screenout too early. If the proppant is too small, it will not provide the fluid conductivity to enhance production. See, for example, W. J. McGuire and V. J. Sikora, “The Effect of Vertical Fractures on Well Productivity,” Trans., AIME (1960) 219, 401-403. In the case of fracturing relatively permeable or even tight-gas reservoirs, a proppant pack should provide higher permeability than the matrix of the formation. In the case of fracturing ultra-low permeable formations, such as shale formations, a proppant pack should provide for higher permeability than the naturally occurring fractures or other micro-fractures of the fracture complexity.

Appropriate sizes of particulate for use as a proppant are typically in the range from about 8 to about 100 U.S. Standard Mesh. A typical proppant is sand-sized, which geologically is defined as having a largest dimension ranging from about 0.06 millimeters up to about 2 millimeters (mm). (The next smaller particle size class below sand size is silt, which is defined as having a largest dimension ranging from less than about 0.06 mm down to about 0.004 mm) As used herein, proppant does not mean or refer to suspended solids, silt, fines, or other types of insoluble solid particulate smaller than about 0.06 mm (about 230 U.S. Standard Mesh). Further, it does not mean or refer to particulates larger than about 3 mm (about 7 U.S. Standard Mesh).

The proppant is sufficiently strong, that is, has a sufficient compressive or crush resistance, to prop the fracture open without being deformed or crushed by the closure stress of the fracture in the subterranean formation. For example, for a proppant material that crushes under closure stress, a 20/40 mesh proppant preferably has an API crush strength of at least 4,000 psi closure stress based on 10% crush fines according to procedure API RP-56. A 12/20 mesh proppant material preferably has an API crush strength of at least 4,000 psi closure stress based on 16% crush fines according to procedure API RP-56. This performance is that of a medium crush-strength proppant, whereas a very high crush-strength proppant would have a crush-strength of about 10,000 psi. In comparison, for example, a 100-mesh proppant material for use in an ultra-low permeable formation such as shale preferably has an API crush strength of at least 5,000 psi closure stress based on 6% crush fines. The higher the closing pressure of the formation of the fracturing application, the higher the strength of proppant is needed. The closure stress depends on a number of factors known in the art, including the depth of the formation.

Further, a suitable proppant should be stable over time and not dissolve in fluids commonly encountered in a well environment. Preferably, a proppant material is selected that will not dissolve in water or crude oil.

Suitable proppant materials include, but are not limited to, silica sand, ground nut shells, ground fruit pits, sintered bauxite, glass, plastics, ceramic materials, processed wood, composite materials, resin coated particulates, and any combination of the foregoing. Mixtures of different kinds or sizes of proppant can be used as well.

In conventional reservoirs, a proppant commonly has a median size anywhere within the range of about 20 to about 100 U.S. Standard Mesh. For a synthetic proppant, it commonly has a median size anywhere within the range of about 8 to about 100 U.S. Standard Mesh.

The concentration of proppant in the treatment fluid depends on the nature of the subterranean formation. As the nature of subterranean formations differs widely, the concentration of proppant in the treatment fluid may be in the range of from about 0.03 kilograms to about 12 kilograms of proppant per liter of liquid phase (from about 0.1 lb/gal to about 25 lb/gal).

Gravel for Gravel Packing

The particulate used for this purpose is referred to as “gravel.” In the oil and gas field, and as used herein, the term “gravel” is refers to relatively large particles in the sand size classification, that is, particles ranging in diameter from about 0.1 mm up to about 2 mm Generally, a particulate having the properties, including chemical stability, of a low-strength proppant is used in gravel packing. An example of a commonly used gravel packing material is sand having an appropriate particulate size range.

Coated Particulate

In some proppant fracturing or gravel packing applications, a resinous material can be coated on the particulate. The term “coated” does not imply any particular degree of coverage on the particulate, which coverage can be partial or complete.

For various purposes, the gravel particulates also may be coated with certain types of materials, including resins, tackifying agents, and the like. For example, a tackifying agent can help with fines and resins can help to enhance conductivity (e.g., fluid flow) through the gravel pack.

As used herein, the term “resinous material” means a material that is a viscous liquid and has a sticky or tacky characteristic when tested under Standard Laboratory Conditions. A resinous material can include a resin, a tackifying agent, and any combination thereof in any proportion. The resin can be or include a curable resin.

### Other Fluid Additives

In certain embodiments, the treatment fluids also can optionally comprise other commonly used fluid additives, such as those selected from the group consisting of surfactants, bactericides, fluid-loss control additives, stabilizers, chelants, scale inhibitors, corrosion inhibitors, hydrate inhibitors, clay stabilizers, salt substitutes (such as trimethyl ammonium chloride), relative permeability modifiers (such as HPT-1™ commercially available from Halliburton Energy Services, Duncan, Okla.), sulfide scavengers, fibers, nanoparticles, and any combinations thereof. Of course, additives should be selected for not interfering with the purpose of the fluid.

Methods of Treating a Well with the Fluid

According to another embodiment of the invention, a method of treating a well, is provided, the method including the steps of: forming a treatment fluid according to the invention; and introducing the treatment fluid into the well.

A fluid can be prepared at the job site, prepared at a plant or facility prior to use, or certain components of the fluid can be pre-mixed prior to use and then transported to the job site. Certain components of the fluid may be provided as a “dry mix” to be combined with fluid or other components prior to or during introducing the fluid into the well.

In certain embodiments, the preparation of a fluid can be done at the job site in a method characterized as being performed “on the fly.” The term “on-the-fly” is used herein to include methods of combining two or more components wherein a flowing stream of one element is continuously introduced into flowing stream of another component so that the streams are combined and mixed while continuing to flow as a single stream as part of the on-going treatment. Such mixing can also be described as “real-time” mixing.

Often the step of delivering a fluid into a well is within a relatively short period after forming the fluid, e.g., less within 30 minutes to one hour. More preferably, the step of delivering the fluid is immediately after the step of forming the fluid, which is “on the fly.”

It should be understood that the step of delivering a fluid into a well can advantageously include the use of one or more fluid pumps.

In an embodiment, the step of introducing is at a rate and pressure below the fracture pressure of the treatment zone.

In an embodiment, the step of introducing comprises introducing under conditions for fracturing a treatment zone. The fluid is introduced into the treatment zone at a rate and pressure that are at least sufficient to fracture the zone.

In an embodiment, the step of introducing comprises introducing under conditions for gravel packing a treatment zone.

After the step of introducing a fluid comprising, the method preferably includes a step of allowing time for the fluid to break in the well. This preferably occurs with time under the design conditions in the portion of the well or zone where the treatment fluid has been placed.

In an embodiment, the step of flowing back is within 7 days of the step of introducing. In another embodiment, the step of flowing back is within 5 days of the step of introducing. Most preferably, the step of flowing back is in the range of about 2 days to about 5 days of the step of introducing.

Preferably, after any such well treatment, a step of producing hydrocarbon from the subterranean formation is the desirable objective.

### Sand Control and Gravel Packing

An example of a treatment method that can benefit from the rheological properties of a treatment fluid viscosified with diutan is gravel packing.

Gravel packing is commonly used as a sand-control method to prevent production of formation sand or other fines from a poorly consolidated subterranean formation. In this context, “fines” are tiny particles, typically having a diameter of 43 microns or smaller, that have a tendency to flow through the formation with the production of hydrocarbon. The fines have a tendency to plug small pore spaces in the formation and block the flow of oil. As all the hydrocarbon is flowing from a relatively large region around the wellbore toward a relatively small area around the wellbore, the fines have a tendency to become densely packed and screen out or plug the area immediately around the wellbore. Moreover, the fines are highly abrasive and can be damaging to pumping and oilfield other equipment and operations.

Placing a relatively larger particulate near the wellbore helps filter out the sand or fine particles and prevents them from flowing into the well with the produced fluids. The primary objective is to stabilize the formation while causing minimal impairment to well productivity.

In one common type of gravel packing, a mechanical screen is placed in the wellbore and the surrounding annulus is packed with a particulate of a larger specific size designed to prevent the passage of formation sand or other fines. The screen holds back gravel during flow back. It is also common, for example, to gravel pack after a fracturing procedure, and such a combined procedure is sometimes referred to as a “frac-packing.”

A screenout is a condition encountered during some gravel-pack operations wherein the treatment area cannot accept further packing gravel (larger sand). Under ideal conditions, this should signify that the entire void area has been successfully packed with the gravel. However, if screenout occurs earlier than expected in the treatment, it may indicate an incomplete treatment and the presence of undesirable voids within the treatment zone.

Like with placing a proppant in a subterranean formation during hydraulic fracturing, in gravel packing a viscosified fluid can be used to help transport and place the gravel in the well.

Gravel packing methods can include a step of designing or determining a gravel packing treatment for a treatment zone of the subterranean formation. According to an embodiment, the step of designing can include: (a) determining the design temperature and design pressure; (b) determining the total designed pumping volume of the one or more treatment fluids to be pumped into the treatment zone; (c) determining the pumping time and rate; (d) designing the treatment fluid, including its composition and rheological characteristics; (e) designing the pH of the continuous phase of the treatment fluid, if water-based; (f) determining the size of a gravel; and (g) designing the loading of the gravel in the fluid.

### CONCLUSION

Therefore, the present invention is well adapted to attain the ends and advantages mentioned as well as those that are inherent therein.

The exemplary fluids disclosed herein may directly or indirectly affect one or more components or pieces of equipment associated with the preparation, delivery, recapture, recycling, reuse, or disposal of the disclosed fluids. For example, the disclosed fluids may directly or indirectly affect one or more mixers, related mixing equipment, mud pits, storage facilities or units, fluid separators, heat exchangers, sensors, gauges, pumps, compressors, and the like used generate, store, monitor, regulate, or recondition the exemplary fluids. The disclosed fluids may also directly or indirectly affect any transport or delivery equipment used to convey the fluids to a well site or downhole such as, for example, any transport vessels, conduits, pipelines, trucks, tubulars, or pipes used to fluidically move the fluids from one location to another, any pumps, compressors, or motors (e.g., topside or downhole) used to drive the fluids into motion, any valves or related joints used to regulate the pressure or flow rate of the fluids, and any sensors (i.e., pressure and temperature), gauges, or combinations thereof, and the like. The disclosed fluids may also directly or indirectly affect the various downhole equipment and tools that may come into contact with the chemicals/fluids such as, but not limited to, drill string, coiled tubing, drill pipe, drill collars, mud motors, downhole motors or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope of the present invention.

The various elements or steps according to the disclosed elements or steps can be combined advantageously or practiced together in various combinations or sub-combinations of elements or sequences of steps to increase the efficiency and benefits that can be obtained from the invention.

It will be appreciated that one or more of the above embodiments may be combined with one or more of the other embodiments, unless explicitly stated otherwise.

The invention illustratively disclosed herein suitably may be practiced in the absence of any element or step that is not specifically disclosed or claimed.

Furthermore, no limitations are intended to the details of construction, composition, design, or steps herein shown, other than as described in the claims.

1. A fluid comprising:
(i) water;
(ii) one or more salts selected from the group consisting of alkali metal halide salts, alkaline earth metal halide salts, and any combination thereof;
(iii) a viscosifier selected from the group consisting of diutan, a diutan derivative, scleroglucan, a scleroglucan derivative, and any combination thereof; and
(iv) a delayed-release source of a weak acid;
wherein the initial pH of the fluid is at least 6.

2. The fluid according to claim 1, wherein the fluid is a water-based fluid.

3. The fluid according to claim 1, wherein the one or more salts comprise: a bromide salt.

4. The fluid according to claim 1, wherein the one or more salts are in at least a sufficient concentration to provide an aqueous solution having a density greater than 10 ppg.

5. The fluid according to claim 1, wherein the diutan is in at least a sufficient concentration in the fluid such that the fluid has an apparent viscosity of at least about 25 mPa·s (cP) at a shear rate of 511 sec⁻¹ upon hydration of the diutan.

6. The fluid according to claim 1, wherein the weak acid has a pKa in the range of about 2.5 to about 5.5.

7. The fluid according to claim 1, wherein the delayed-release source of the weak acid is selected from the group consisting of: esters of formic acid, acetic acid, or lactic acid, polylactides, diethylene glycol diformate, and triisopropyl orthoformate, and any combination thereof.

8. The fluid according to claim 1, wherein the delayed-release source of the weak acid is in at least a sufficient concentration to break the viscosity of the fluid.

9. The fluid according to claim 1, wherein the initial pH of the fluid is in the range of about 6 to about 7.

10. The fluid according to claim 1, wherein the fluid additionally comprises a solid particulate.

11. A method of treating a portion of a well, the method comprising the steps of:
(A) forming a fluid comprising:
(i) water;
(ii) one or more salts selected from the group consisting of alkali metal halide salts, alkaline earth metal halide salts, and any combination thereof;
(iii) a viscosifier selected from the group consisting of diutan, a diutan derivative, scleroglucan, a scleroglucan derivative, and any combination thereof; and
(iv) a delayed-release source of a weak acid;
wherein an initial pH of the fluid is at least 6; and
(B) introducing the fluid into the portion of the well.

12. The method according to claim 11, wherein the fluid is a water-based fluid.

13. The method according to claim 11, wherein the one or more salts comprise: a bromide salt.

14. The method according to claim 11, wherein the one or more salts are in at least a sufficient concentration to provide an aqueous solution having a density greater than 10 ppg.

15. The method according to claim 11, wherein the diutan is in at least a sufficient concentration in the fluid such that the fluid has an apparent viscosity of at least about 25 mPa·s (cP) at a shear rate of 511 sec⁻¹ upon hydration of the diutan.

16. The method according to claim 11, wherein the weak acid has a pKa in the range of about 2.5 to about 5.5.

17. The method according to claim 11, wherein the delayed-release source of the weak acid is selected from the group consisting of: esters of formic acid, acetic acid, or lactic acid, polylactides, diethylene glycol diformate, and triisopropyl orthoformate, and any combination thereof.

18. The method according to claim 11, wherein the delayed-release source of the weak acid is in at least a sufficient concentration to break the viscosity of the fluid.

19. The method according to claim 11, wherein the initial pH of the fluid is in the range of about 6 to about 7.

20. The method according to claim 11, wherein the fluid additionally comprises a solid particulate.

21. The method according to claim 20, wherein the method additionally comprises the step of: forming a gravel pack in the portion of the well.
